(19) United States
(12) Patent Application Publication
(10) Pub. No.: US 2026/0178665 A1
(43) Pub. Date: Jun. 25, 2026

(54) ROBUST AND ACCURATE COMPUTATION OF PV GENERATOR RELATIVE LOCATIONS FOR AUTO MAPPING

(71) Applicant: HANWHA SOLUTIONS CORPORATION, Seoul (KR)

(72) Inventors: Mudhafar Hassan-Ali, Menlo Park, CA (US); Adrian Voicu, Santa Clara, CA (US)

(73) Assignee: HANWHA SOLUTIONS CORPORATION, Seoul (KR)

(21) Appl. No.: 19/427,457

(22) Filed: Dec. 19, 2025

Related U.S. Application Data
(60) Provisional application No. 63/736,221, filed on Dec. 19, 2024.

(51) Int. Cl. G06F 16/901; G06F 18/2137; H04W 4/02

(52) U.S. Cl. CPC G06F 16/9024; G06F 18/2137; H04W 4/023

(57) ABSTRACT

A computing device may include processing circuitry configured to execute the computer readable instructions to obtain a plurality of distance measurements between a plurality of photovoltaic (PV) generators, the distance measurements determined based on time-of-flight wireless signal data transmitted between the plurality of PV generators, generate an initial adjacency matrix based on the plurality of distance measurements, generate an initial graph of the plurality of PV generators based on the initial adjacency matrix, generate a map corresponding to locations of the plurality of PV generators based on the initial graph, and display the map on a graphical user interface.

### CROSS-REFERENCE TO RELATED APPLICATIONS

This application claims the benefit of priority under 35 U.S.C. § 119 to U.S. Provisional Application No. 63/736,221, filed on Dec. 19, 2024, the entire contents of which are incorporated herein by reference.

### BACKGROUND

Various example embodiments relate to computing devices for robustly and accurately computing the relative location of a plurality of photovoltaic (PV) generators (e.g., PV modules, solar panels, etc.) and automatically mapping the plurality of PV generators, a system including the computing device, a method for automatically mapping the plurality of PV generators, and/or a non-transitory computer readable medium including computer readable instructions for performing the method.

During the commissioning of new PV generator arrays and/or modification of existing arrays PV generator location mapping (e.g., array layout) is performed. The mapping (e.g., PV generator layout) is important for managing the individual PV generator as a power generating source and as an asset that needs to be tracked periodically. Typically, the mapping is performed manually by a human technician by assigning unique IDs to each PV generator, such as labeling the individual PV generators with a quick response (QR) code, and manually determining the geographic locations of at least one of the PV generators and measuring the distances between each of the PV generators, before generating the map of the PV generator layout. However, this method of mapping PV generators is expensive in terms of manual effort and cost, is time consuming, and is error prone.

Alternatively, a map of the PV generator layout may be determined by installing location sensors, such as Global Positioning System (GPS) sensors, in each PV generator, which reduces the number of errors in the generated map, but greatly increases the expense of generating the map. Moreover, locations obtained via GPS sensors may have an accuracy of 3 to 5 meters in areas with an unobstructed view of the sky, whereas locations obtained via GPS sensors in areas with an obstructed view of the sky may have accuracy in the range of 10 to 20 meters, which may be insufficient for the purposes of the PV generator location mapping.

Therefore, a method of automatically determining the location and adjacency of the individual PV generators using relative location data would reduce installation, maintenance, and/or asset-tracking times and costs.

### SUMMARY

At least one example embodiment is directed to a computing device. In at least one example embodiment, the computing device may include memory having computer readable instructions stored thereon; and processing circuitry configured to execute the computer readable instructions to cause the computing device to, obtain a plurality of distance measurements between a plurality of photovoltaic (PV) generators, the distance measurements determined based on time-of-flight wireless signal data transmitted between the plurality of PV generators, generate an initial adjacency matrix based on the plurality of distance measurements, generate an initial graph of the plurality of PV generators based on the initial adjacency matrix, generate a map corresponding to locations of the plurality of PV generators based on the initial graph, and display the map on a graphical user interface.

At least one example embodiment is directed to a photovoltaic (PV) generator system. In at least one example embodiment, the PV generator system may include a plurality of PV generators; and at least one computing device configured to, obtain a plurality of distance measurements between a plurality of PV generators, the distance measurements determined based on time-of-flight wireless signal data transmitted between the plurality of PV generators, generate an initial adjacency matrix based on the plurality of distance measurements, generate an initial graph of the plurality of PV generators based on the initial adjacency matrix, generate a map corresponding to locations of the plurality of PV generators based on the initial graph, and display the map on a graphical user interface.

At least one example embodiment is directed to method of operating a computing device. In at least one example embodiment, the method may include obtaining a plurality of distance measurements between a plurality of photovoltaic (PV) generators, the distance measurements determined based on time-of-flight wireless signal data transmitted between the plurality of PV generators, generating an initial adjacency matrix based on the plurality of distance measurements, generating an initial graph of the plurality of PV generators based on the initial adjacency matrix, generate a map corresponding to locations of the plurality of PV generators based on the initial graph, displaying the map on a graphical user interface.

### BRIEF DESCRIPTION OF THE DRAWINGS

The example embodiments will become more fully understood from the detailed description given herein below and the accompanying drawings, wherein like elements are represented by like reference numerals, which are given by way of illustration only and thus are not limiting of this disclosure.

FIG. 1 illustrates an example of a photovoltaic generator according to at least one example embodiment;

FIG. 2 is a block diagram illustrating an example computing device according to at least one example embodiment;

FIG. 3 illustrates an example of an array of PV generators according to at least one example embodiment;

FIG. 4 illustrates an example diagram for determining adjacency in an array of PV generators;

FIG. 5 illustrates an example diagram for determining time of arrival (ToA) between an initiator and a responder according to at least one example embodiment;

FIG. 6 is a flowchart illustrating an example method for generating a PV map using relative location data according to at least one example embodiment;

FIGS. 7A to 7D illustrate example graphs corresponding to a PV array generated by the method of FIG. 6 according to at least one example embodiment;

FIG. 8 illustrates an example generated PV generator map according to at least one example embodiment;

FIG. 9 is a flowchart illustrating an example method for determining the local coordinates of each node in a clique according to some example embodiments; and

FIG. 10 is a flowchart illustrating an example method for performing rigid transformation according to some example embodiments.

### DETAILED DESCRIPTION

Various example embodiments will now be described more fully with reference to the accompanying drawings in which some example embodiments are shown, wherein numbers refer to like elements throughout the description of the figures.

Detailed illustrative example embodiments are disclosed herein. However, specific structural and functional details disclosed herein are merely representative for purposes of describing example embodiments. The example embodiments may, however, be embodied in many alternate forms and should not be construed as limited to only the example embodiments set forth herein.

Accordingly, while example embodiments are capable of various modifications and alternative forms, the embodiments are shown by way of example in the drawings and will be described herein in detail. Therefore, it should be understood that there is no intent to limit example embodiments to the particular forms disclosed. On the contrary, example embodiments are to cover all modifications, equivalents, and alternatives falling within the scope of this disclosure.

It will be appreciated that a number of example embodiments described herein may be used in combination.

As discussed herein, the terminology “one or more” and “at least one” may be used interchangeably.

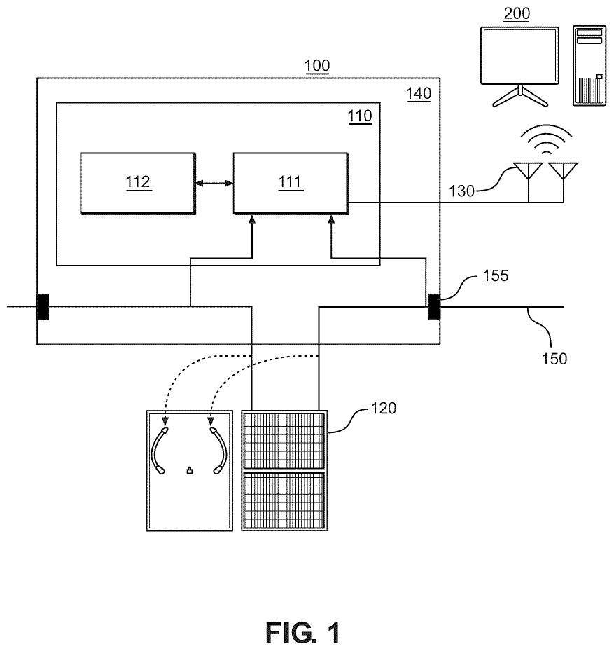

FIG. 1 illustrates an example of a photovoltaic (PV) generator 100 (e.g., a PV module, a solar panel, etc.). The PV generator 100 may include a Module Level Power Electronics (MLPE) 10 (e.g., a microinverter, etc.), at least one PV generator 120, a communication interface 130, and power line couplings 155, etc. The PV generator 100 may be configured to communicate with at least one external device 200, such as a gateway computer, a server, a personal computer, a laptop, a smart device, etc., but is not limited thereto.

According to at least one example embodiment, the PV generator 120 may include a plurality of PV cells sealed in, e.g., an environmentally protective laminate and/or a protective transparent material, etc. In the PV generator, the PV cells may be connected in parallel and/or in series, and may collect energy from sunlight and convert the collected energy into electricity via the photovoltaic effect. The PV generator 120 may further include at least a pair of conductive contacts, with one of the contacts configured to operate as an output for the power generated by the PV cells and the other contact configured to operate as an input to complete the circuit. The PV cells are configured to produce power (e.g., energy, electricity, electrical current, etc.) in response to stimulation from radiation (e.g., solar radiation, etc.). For example, in at least one example, the PV cells are configured to operate as electron pumps in response to stimulation from photons from sunlight. In at least one example embodiment, each of the PV cells may comprise at least one of a photovoltaic crystalline, polycrystalline, amorphous, and/or thin film semiconductor structure, but are not limited thereto.

In at least one example embodiment, a plurality of the PV generator 120 may be included in a PV panel (not illustrated), and a plurality of PV panels may be included in a PV array (not illustrated).

According to at least one example embodiment, the MLPE 110 is configured to perform maximum power point tracking (MPPT) at the PV generator level. For example, in at least one example embodiment, the MLPE 110 may be configured to control and/or adjust the operational current and/or voltage combinations of the PV generator 120 (and/or a plurality of the PV generator 120 in an array) to maximize power output based on, e.g., changes to the power output by the PV generator 120, etc. For example, the MLPE 110 may be configured to monitor the current produced by the PV generator 120 and to adjust the voltage in response to a change in current due to, e.g., time of day, weather conditions, shading and/or contaminate (e.g., dirt, soil, water, smog, and/or the like), etc., on the PV generator 120, deterioration and/or damage to the PV generator 120, etc., but the example embodiments are not limited thereto. Though the example illustrated in FIG. 1 shows the MLPE 110 monitoring a single PV generator 120, the examples are not limited thereto, and, for example, in at least some example embodiments, the MLPE 110 may be configured to monitor and manage each of a plurality of PV generators in, e.g., a PV panel, at least a section of a PV array, and/or the PV array, etc.

The MLPE 110 may include processing circuitry 111 and memory 112, etc., but is not limited thereto. The processing circuitry 111 may include hardware or hardware circuit including logic circuits; a hardware/software combination such as a processor executing software and/or firmware; or a combination thereof. For example, the processing circuitry more specifically may include (and/or be included in) a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc., but is not limited thereto.

The memory 112 may include computer-readable program code stored in a computer-readable medium. The computer-readable program code may be provided to a variety of computers or processors of other data processing devices. The computer readable media may be, for example, a non-transitory computer readable media. The term “non-transitory,” as used herein, is a description of the medium itself (e.g., as tangible, and not a signal) as opposed to a limitation on data storage persistency (e.g., volatile memory vs. non-volatile memory, etc.). For example, the computer-readable recording medium may be any tangible medium that can store or include the program in or connected to an instruction execution system, equipment, or device, and may include a random access memory (RAM), a read only memory (ROM), and/or a non-volatile mass storage device, such as a disk drive, and/or a solid state drive, etc. The memory 112 may include, for example, special purpose computer readable instructions to be executed by the processing circuitry 111, which enable and/or cause the processing circuitry 111 to perform operations in accordance with one or more methods of the example embodiments. In at least some example embodiments, such computer readable instructions may be loaded from a non-transitory computer-readable storage medium independent of the memory 230, using a drive mechanism (not illustrated) and/or computer readable instructions loaded via a network connection, etc. For example, the memory 112 may include various special purpose program code including the computer executable instructions which may cause the PV generator 120 to perform the one or more of the methods of the example embodiments.

Additionally, the processing circuitry 111 is configured to execute processes by retrieving the program code (e.g., the computer readable instructions) and data from the memory 112 to process them, thereby executing special purpose control and functions of the entire PV generator 120. Once the special purpose program instructions are loaded into the processing circuitry 111, the processing circuitry 111 executes the special purpose program instructions, thereby transforming the processing circuitry 111 into a special purpose processor.

In at least one example embodiment the processing circuitry 111 and the memory 112 may be included, e.g., as a printed circuit board assembly (PCBA), a system-on-chip, and/or the like.

In at least one example embodiment, the MLPE 110 may further include an MLPE enclosure 140 protecting the processing circuitry 111, the memory 112, etc.

The PV generator 100 further includes at least one communication interface 130. The communication interface 130 may be a wireless communication interface including one or more antenna, but is not limited thereto. In at least one example embodiment, the communication interface 130 may further include at least one wired communication interface (e.g., an Ethernet connection, a power line communication (PLC) connection, etc.). For example, the communication interface 130 may be configured to establish a wireless connection and to wirelessly communicate with another wireless communication interface. For example, the communication interface 130 may be configured to establish a least one of an ultra-wide band (UWB) connection, a Bluetooth connection, a Wireless Fidelity (WiFi) connection, a wireless mesh network connection, a cellular network connection, and/or the like.

In at least one example embodiment, the communication interface 130 may be configured to communicate with a gateway computer 200 and/or to a user device (e.g., a smartphone, a computer, a laptop, a server, a monitoring device, etc.) (not shown), e.g., through a direct connection and/or through a wireless network connection (e.g., the cellular network connection, the wireless mesh network, etc.) and/or wired network connection. More specifically, in at least one example embodiment, a plurality of PV generators may be configured to establish a wireless network configure to connect the PV generators, and to connect the PV generators to an external device, such as the gateway computer 200, and/or a user device.

The PV generator 100 further includes power line couplings 155 configured to be connected to a power line 150 and to transmit the power generated by the PV generator 120 to the power line 150. In at least some example embodiments, the MLPE 110 may be configured to further communicate with neighboring MLPEs using, e.g., PLC. For brevity and clarity, FIG. 1 illustrates a single PV generator 120 associated with the MLPE 110, but the example embodiments are not limited thereto. For example, the MLPE 110 may be configured to monitor and control the operations of two or more PV generators 120 and/or two or more PV panels, etc.

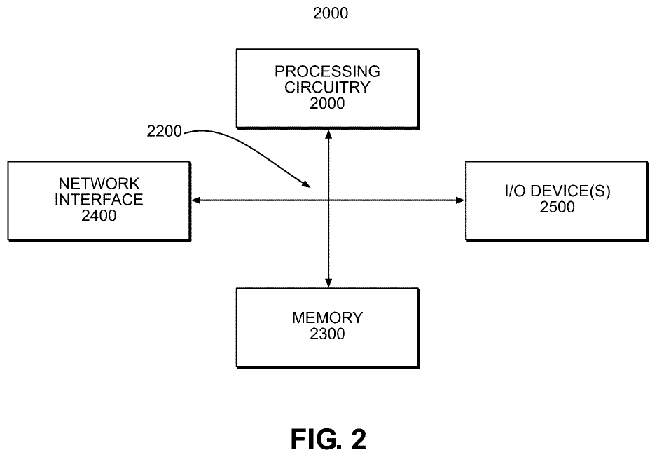

FIG. 2 is a block diagram illustrating an example computing device according to at least one example embodiment. The example computing device 2000 of FIG. 2 may correspond to the MLPE 110 of FIG. 1, the gateway computer 200 of FIG. 1, a user device, etc., but the example embodiments are not limited thereto, and for example, the computing device(s) may employ alternative architectures, etc.

Referring to FIG. 2, a computing device 2000 (e.g., an MLPE, a PC, a laptop, a server, a smart phone, a tablet, etc.) may include processing circuitry 2100, at least one communication bus 2200, a memory 2300, at least one network interface 2400, and/or at least one input/output (I/O) device 2500 (e.g., a keyboard, a touchscreen, a mouse, a microphone, a camera, a speaker, a monitor, a touchscreen, etc.), but the example embodiments are not limited thereto. According to some example embodiments, the computing device 2000 may include a greater or lesser number of constituent components, and for example, the computing device 2000 may also include at least one battery (not shown), at least one sensor, etc., but the example embodiments are not limited thereto. For example, the computing device 2000 may further include one or more sensors, such as proximity sensors (e.g., an infra-red proximity sensor, a capacitive proximity sensor, etc.), location sensors (e.g., GPS, GLONASS, Beidou, Galileo, etc.), other sensors (e.g., thermometers, humidity sensors, pressure sensors, motion sensors, accelerometers, etc.), etc., one or more actuators, etc., but is not limited thereto. Additionally, one or more elements of the computing device 2000, such as the I/O device 2500, etc., may be optional.

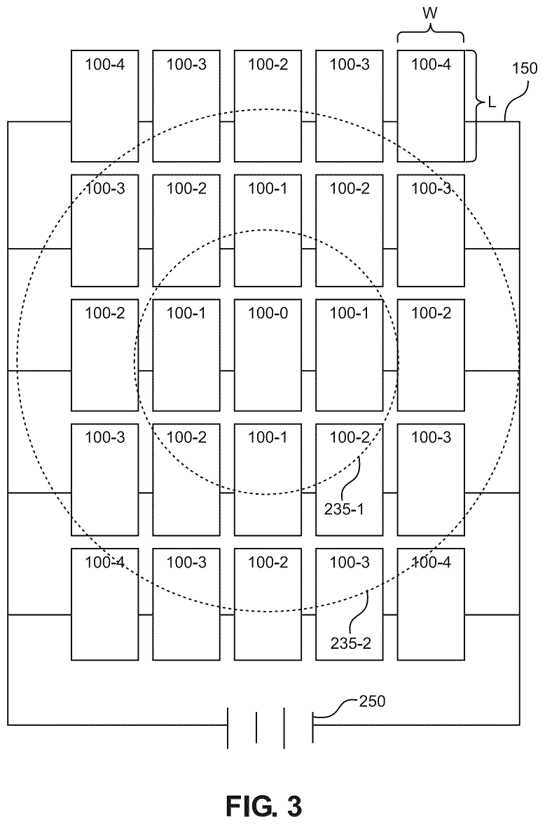

In at least one example embodiment, the processing circuitry 2100 may include at least one processor (and/or processor cores, distributed processors, networked processors, etc.), which may be configured to control one or more elements of the computing device 2000 and/or control one or more elements of the PV generator 100, the MLPE 110, an energy storage system (not shown), etc. The processing circuitry 2100 is configured to execute processes by retrieving special purpose program code (e.g., special purpose computer readable instructions) and data from the memory 2300 to process them, thereby executing special purpose control and functions of the entire computing device 2000, such as the special purpose PV generator mapping operations associated with FIGS. 3 to 7, etc., but is not limited thereto. Once the special purpose program instructions are loaded into the processing circuitry 2100, the processing circuitry 2100 executes the special purpose program instructions, thereby transforming the processing circuitry 2100 into special purpose processing circuitry.

In at least one example embodiment, the memory 2300 may be a non-transitory computer-readable storage medium and may include a random access memory (RAM), a read only memory (ROM), and/or a permanent mass storage device such as a disk drive, and/or a solid state drive, etc. Stored in the memory 2300 is special purpose program code (i.e., special purpose computer readable instructions) related to PV generator mapping operations, etc., such as the methods discussed in connection with FIGS. 3 to 7, etc. Such software elements may be loaded from a non-transitory computer-readable storage medium independent of the memory 2300, using a drive mechanism (not shown) connected to the computing device 2000, or via the network interface 2400, etc.

In at least one example embodiment, the at least one communication bus 2200 may enable communication and data transmission/reception to be performed between elements of the computing device 2000, and/or monitor the status of the elements of the computing device 2000 and/or the PV generator 100, the MLPE 110, an energy storage system, etc. The bus 2200 may be implemented using a high-speed serial bus, a parallel bus, and/or any other appropriate communication technology. According to at least one example embodiment, the computing device 2000 may include a plurality of communication buses (not shown), such as an address bus, a data bus, etc.

The computing device 2000 may also include at least one network interface 2400, but is not limited thereto. The network interface 2400 may include at least one wireless transceiver which may be used to transmit and/or receive wireless signals in accordance with at least one desired radio access technology, such as UWB, Bluetooth, Wi-Fi, 4G LTE, 5G NR, 6G, etc. For example, the computing device 2000 may communicate with a core network (e.g., backend network, backhaul network, backbone network, data network, or another network) of a wireless communication network and/or a data network via the network interface 2400. Additionally, or alternatively, the network interface 2400 may be a wired network interface and may enable the computing device 2000 to communicate and/or transmit data to and from to network devices on the backend network, such as a core network gateway (not illustrated), a data network (not illustrated), such as the Internet, intranets, wide area networks, telephone networks, and/or VoIP networks, etc.

While FIG. 2 depicts an example embodiment of a computing device 2000 which may operate as a server, the example embodiments are not limited thereto, and may include additional and/or alternative architectures that may be suitable for the purposes demonstrated.

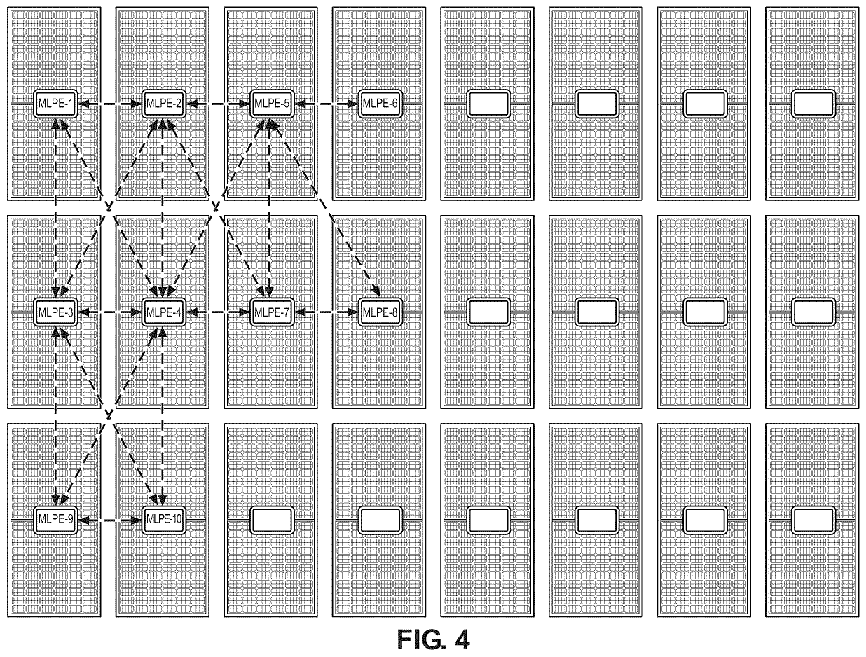

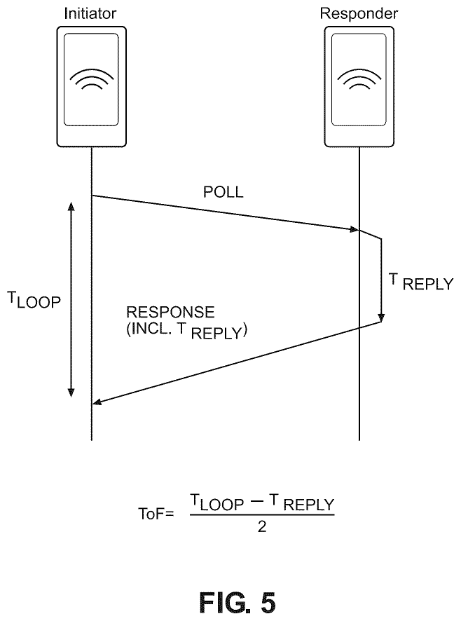

FIG. 3 illustrates an example of an array of PV generators 100-1 through 104-4; FIG. 4 illustrates an example diagram for determining adjacency in an array of PV generators; and FIG. 5 illustrates an example diagram for determining time of arrival (ToA) between an initiator and a responder according to at least one example embodiment. While FIGS. 3 and 4 illustrate an array of PV generators arranged in a two-dimensional grid for the sake of clarity, the example embodiments are not limited thereto, and for example, the arrangement of the array of PV generators may further include a third dimension (e.g., a vertical component).

According to at least one example embodiment, a PV generator (e.g., the PV generator 100 of FIG. 1) may be included in a plurality of PV generators 100-0, 101-1 through 101-4, 102-1 through 102-4, 103-1 through 103-112-3 and 101-4 through 104-4, but the example embodiments are not limited thereto. In at least one example embodiment, the plurality of PV generators 100-0 to 104-4 may be included in a grid configuration (e.g., including a plurality of columns and rows, as illustrated), a honeycomb-like configuration (e.g., including a plurality of staggered rows or columns, not illustrated), a linear configuration (e.g., a plurality of PV generators in a line), a polygonal configuration, etc., but are not limited thereto. According to some example embodiments, the plurality of PV generators 100-0 to 104-4 may be arranged at a same vertical height and/or at different vertical heights. For example, the plurality of PV generators 100-0 to 104-4 may be on a flat surface, an incline, mound, depression, and/or the like.

Each of the plurality of the PV generators may be adjacent to a number of first-order adjacent PV generators, wherein, the first-order adjacent PV generators represent the nearest neighboring PV generators to the referenced/selected PV generator. For example, a PV generator in the corner of the grid array (e.g., one of the PV generators 101-4 through 104-4) may include 2 (two) first-order adjacent PV generators, a PV generator in an edge of the grid array but not the corner (e.g., one of the PV generators 101-3 through 112-3) may include 3 (three) first-order adjacent PV generators, and a PV generator in the grid array but not in the corner or edge (e.g., PV generators 100-0 through 102-4) may include 4 (four) first-order adjacent PV generators. For example, using PV generator 100-0 as a reference, each of the PV generators in the grid array, but not in a corner or edge, includes a plurality of first-order adjacent PV generators 101-1 through 104-1. Alternatively, a PV generator in the corner of the honeycomb array may include 2 (two) first-order adjacent PV generators, a PV generator in an edge of the honeycomb array but not the corner may include 3 (three) to 5 (five) first-order adjacent PV generators, and an PV generator in the grid array but not in the corner or edge may include 6 (six) first-order adjacent PV generators, etc.

In the array of PV generators, one or more subsets of the PV generators, such as a row or column of at least some of the PV generators may be connected in series, but the examples are not limited thereto. For example, in at least one example embodiment, each of the PV generator included in a row of the array of PV generators may be connected as a string or chain (e.g., in series) and each of the rows may be connected in parallel. Alternatively, in at least some example embodiments, the PV generators in the array (and/or components thereof) may be connected in parallel. For example, the array may be configured such that if one of the PV generators breaks-down, an interruption in the supply of energy by the other PV generators in the array does not occur. The array may be further connected to a power load 250, such as a power grid, a battery, and/or the like.

In at least some example embodiments, each of the MLPEs included in the PV generators may be configured to establish communication (e.g., at least one of an ultra-wide band (UWB) connection, a Bluetooth connection, a Wireless Fidelity (WiFi) connection, a wireless mesh network connection, a cellular network connection, and/or the like) with each of the first-order adjacent MLPEs included in the first-order adjacent PV generators. By establishing communication with the neighboring MLPEs, a neighborhood network may be formed, thereby enabling communication between MLPEs. Further, since each MLPE in the network enables communication between the neighboring MLPEs, the use of additional hardware facilitating communication with the MLPEs (e.g., router hubs, repeaters, etc.) may be reduced and/or omitted, thereby decreasing the cost and complexity of installing and maintaining the PV array. Each MLPE may be further configured to use the communication and/or the establishing of the network in order to obtain relative position data of itself and/or its respective PV generator. For example, in at least one example embodiment, a MLPE included in the PV generator 100-0 may be configured to transmit a ping signal 235-1 with a first intensity (e.g., a first signal strength, a first signal transmission power, etc.), and/or a plurality of ping signals (e.g., 235-1 through 235-n) with increasing intensities (e.g., increasing signal strengths, etc.). For example, the MLPE included in the PV generator 100-0 may transmit a UWB ping, a Bluetooth ping, a Wi-Fi ping, etc., but is not limited thereto. For the sake of clarity, the MLPEs are described as being at the center of the PV generators, but the example embodiments are not limited thereto, and for example, the MLPEs may be located at other positions within the PV generators, such as a corner of the PV generator, etc.

In at least one example embodiment, the MLPE may define a neighboring MLPE that responds to the first ping 235-1 as a first-order adjacent MLPE. For example, in some example embodiments, the intensity of the first ping 235-1 may be set to a level wherein a signal strength of the first ping 235-1 is at or above a threshold for the first-order adjacent MLPEs, and less than the threshold at distances past the first-order threshold.

The intensity (e.g., the signal strength, signal transmission power, etc.) of the first ping 235-1 may be configured to accommodate the widths W and the lengths L of the PV generators. For example, in a case wherein the PV generators are expected and/or designed to be spaced apart by a to-be determined (or preset) distance (“d”), and the length L of the PV generator may be between one to two times the width of the PV generator, the MLPE may set the intensity of the first ping 235-1 such that the intensity level of the signal at a distance of d+0.5 L is equal to the first-order threshold. However, this is only an example, and the example embodiments are not limited thereto. For example, in at least one example embodiment, the MLPE may set the intensity of the first ping 235-1 such that the intensity level of the signal at a distance of d+L is equal to the first-order threshold, thereby including the first-order adjacent PV generators and a sub-set of the second-order adjacent PV generators, etc.

For example, in these cases, as illustrated in FIG. 4, a corner MLPE (e.g., MLPE-1) is configured to establish a wireless connection with the orthogonal first-order adjacent MLPEs (e.g., MLPE-2 and MLPE-3) and the nearest diagonal second-order MLPEs (e.g., MLPE-4). Similarly, an MLPE at an edge of the grid array but not the corner (e.g., MLPE-3) is configured to establish a wireless connection with the orthogonal first-order adjacent MLPEs (e.g., MLPE-1, MLPE 4, and MLPE-9) with the nearest diagonal second-order MLPEs (e.g., MLPE-2, and MLPE 10); and an MLPE not at the edge or corner (e.g., MLPE-4) is configured to establish a wireless connection with the orthogonal first-order adjacent MLPEs (e.g., MLPE-2, MLPE-3, MLPE-7, and MLPE-10) and the nearest diagonal second-order MLPEs (e.g., MLPE-1, MLPE-5, MLPE-9, and MLPE-11). However, the example embodiments are not limited thereto, and for example, the MLPE may establish wireless connections to additional adjacent MLPEs based on the wireless communication range and/or the maximum number of wireless connections supported by the wireless protocol being used, e.g., UWB which has a theoretical maximum wireless communication range of approximately 200 meters with clear line of sight, etc. For example, as shown in FIG. 4, the wireless connection range of the corner MLPE (e.g., MLPE-1) may be limited to MLPE-2 to MLPE-10, and the corner MLPE (e.g., MLEP-1) may not be capable of determining the relative distances between itself and MLPEs that are further away.

According to some example embodiments, each of the MLPEs may further be configured to receive and respond to pings from other MLPEs, and may be configured to establish one or more wireless connections with the one or more MLPEs transmitting the ping(s) (e.g., the initiating MLPEs). The initiating MLPE may be configured to poll one or more receiving MLPEs, e.g., the initiating MLPE may transmit a request to each of the receiving MLPEs, and each of the receiving MLPEs may provide a response, etc. The response may include an indicator of the time to reply (T_{reply}), and the distance between the initiating MLPE and the corresponding receiving MLPE may be determined based on a time of flight (ToF) calculation.

For example, as shown in FIG. 5, an initiator (e.g., an MLPE transmitting the ping) may provide a signal to (e.g., may poll) a responder (e.g., the MLPE responding to the ping) including a timestamp indicating when the signal was transmitted by the initiator, and the responder may be configured to provide a response to the signal including a timestamp indicating when the signal was transmitted by the responder. The response may further include a time-to-reply T_{reply} indicator of the time it took for the responder to respond to the signal, or in other words, the amount of time between when the responder received the signal from the initiator and when it transmitted its response. According to some example embodiments, the initiator may then calculate the distance between itself and the responder based on the calculated amount of time for the responder to receive the signal from the initiator (e.g., a ping transmission time) and/or the calculated amount of time for the initiator to receive the response from the responder (e.g., a ping response time), divided by the transmission speed of radio waves (e.g., approximately the speed of light), but the example embodiments are not limited thereto, and for example, the initiator may forward the information (e.g., timestamps, etc.) associated with the ping transmission time and the ping response time to another MLPE (e.g., a primary MLPE) and/or a computing device (e.g., the gateway computer 200, etc.), which may then calculate the distance between the initiator and the responder, etc. In some example embodiments, if the ping transmission time and the ping response time are not equal, an average of the ping transmission time and the ping response time may be taken and divided by the transmission speed of radio waves, or the initiator may repeat the polling operation, etc.

In at least some example embodiments, the initiator MLPE may include a plurality of transmitters, and the initiator MLPE may be configured to determine a relative angle and/or direction of the responder based on a difference in distance as determined based on the response received by the plurality of transmitters. For example, assuming that the initiator MLPE receives the response from the responder MLPE on two or more transmitters, the initiator MLPE may triangulate the relative position (e.g., the relative angle, the relative elevation, and/or the relative direction, etc.) of the responder MLPE based on the differences in the distances calculated of the same response received on the two or more transmitters.

In at least some example embodiments, the ToF information between the MLPEs may be collected by a gateway computer 200, a user device, and/or a server (not shown) included in or separate from the PV array, and, as described in further detail below, the gateway computer 200, etc., may be configured to determine a neighborhood map based on the determined distances and/or collected ToF information.

According to some example embodiments, all of the MLPEs of the array of PV generators may act as initiators, but the example embodiments are not limited thereto, and for example, a subset of the MLPEs of the array of PV generators may act as initiators. For example, according to at least one example embodiment, during a monitoring mode, only a subset of the MLPEs may be configured as an initiator and/or a gateway computer may select a next MLPE to act as an initiator and may transmit an initiation signal to the selected MLPE, etc., thereby reducing the energy consumption of the array of PV generators.

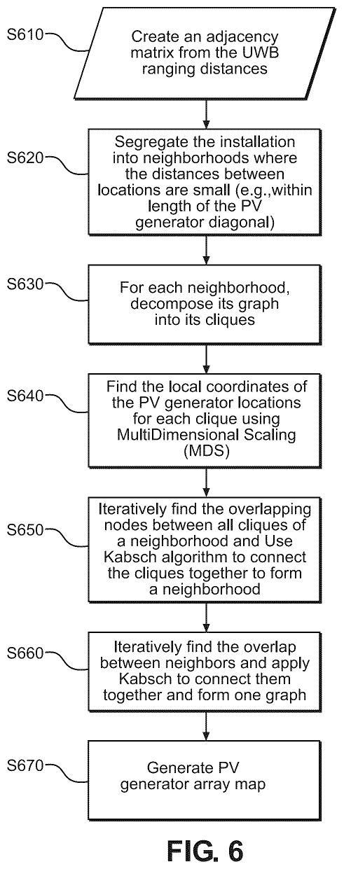

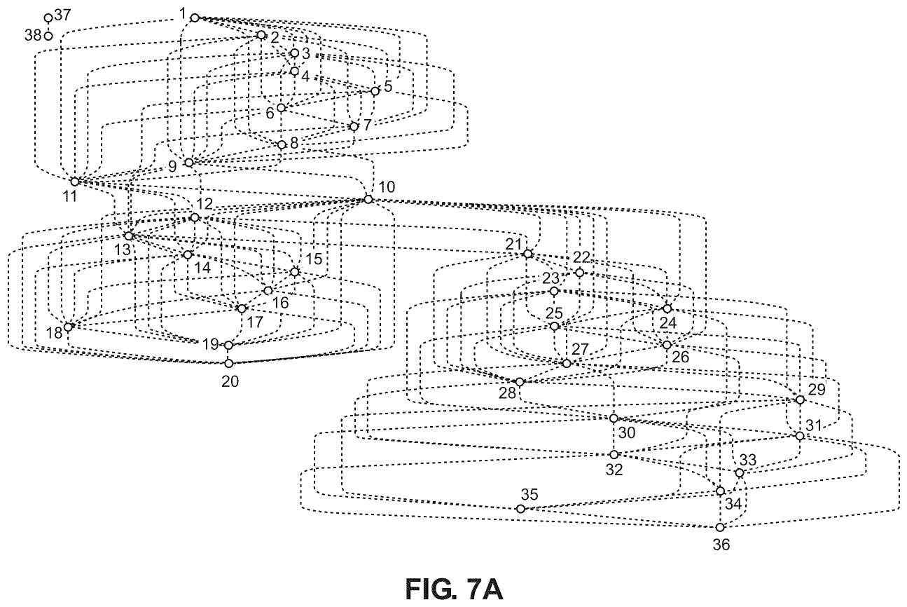

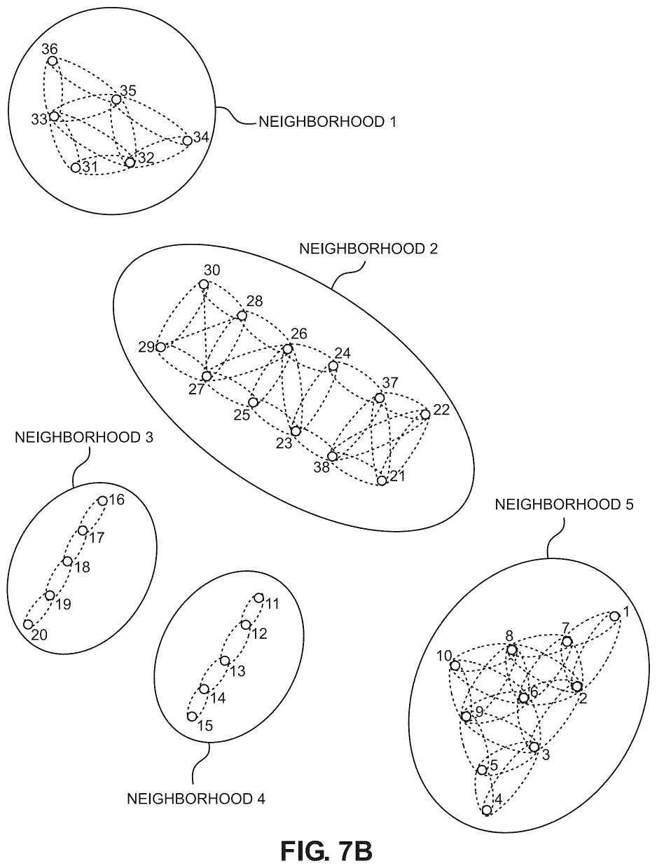

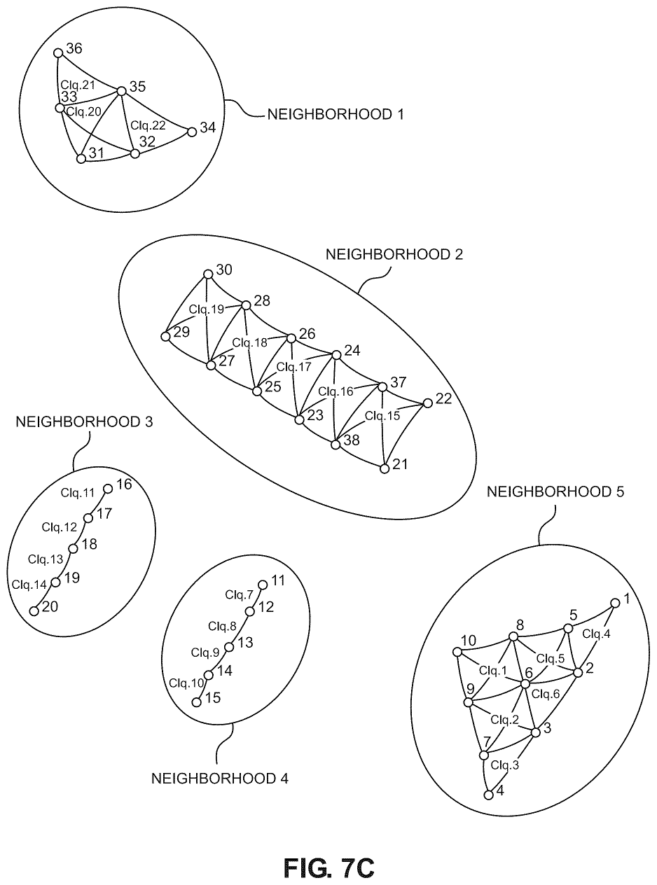

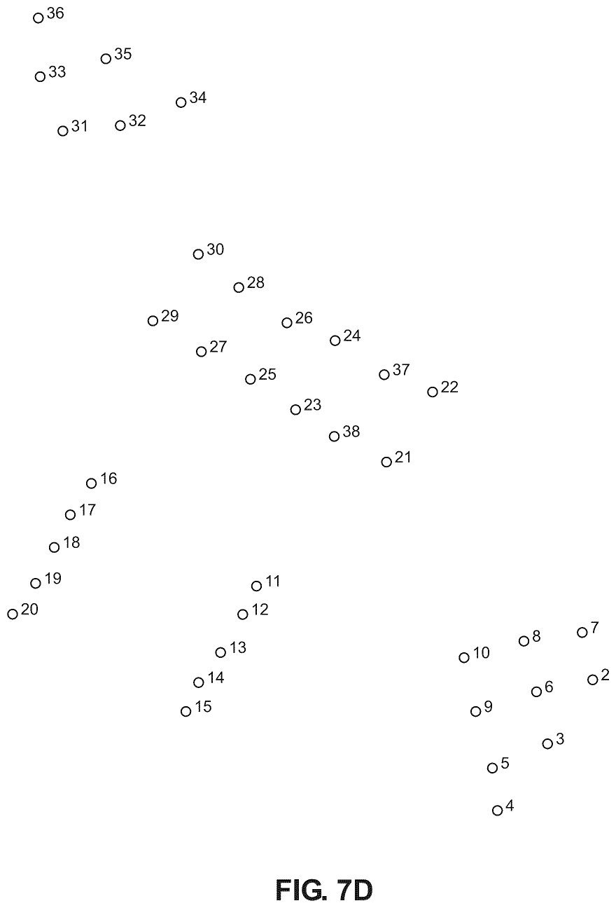

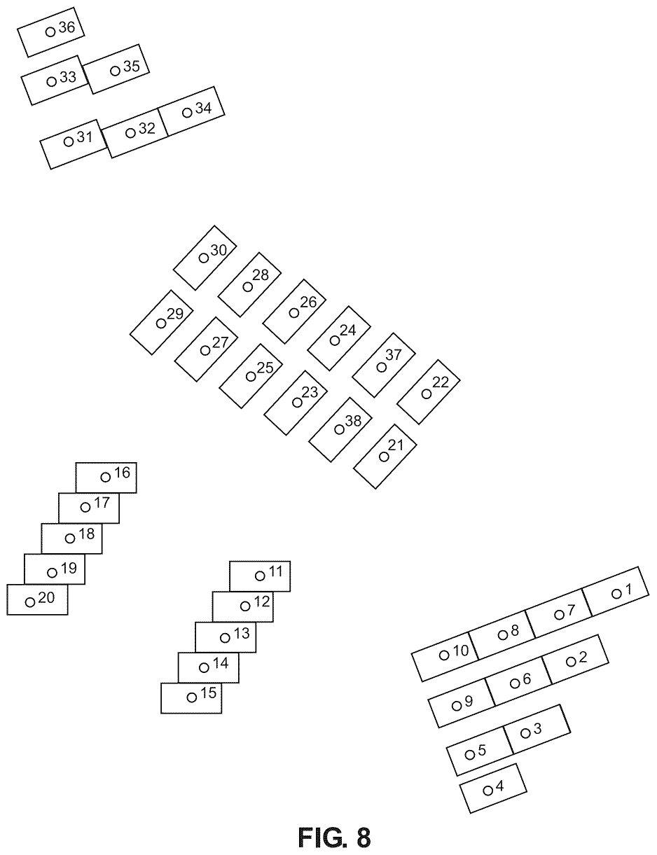

FIG. 6 is a flowchart illustrating an example method for generating a PV map using relative location data according to at least one example embodiment; FIGS. 7A to 7D illustrate example graphs corresponding to a PV array generated by the method of FIG. 6 according to at least one example embodiment; and FIG. 8 illustrates an example generated PV generator map according to at least one example embodiment. In at least some example embodiments, the methods of FIGS. 6, 9, and 10 may be performed by processing circuitry included in at least one electronic device. For example, the processing circuitry may be included in the gateway computer 200, a server, and/or in a separate computer, such as a user device, a laptop, etc., but the example embodiments are not limited thereto. For example, the processing circuitry may include a function as a service (FAAS) and/or cloud computing system, etc. Additionally, while FIGS. 6 to 10 are discussed in terms of two-dimensional coordinates and/or two-dimensional maps for the sake of brevity and clarity, the example embodiments are not limited thereto, and the discussion and/or equations below may be adapted for use with three-dimensional coordinates and/or three-dimensional maps by a person of ordinary skill in the art.

Referring now to FIG. 6, in operation S610, the processing circuitry may generate and/or create at least one adjacency matrix based on ToF distance data obtained by one or more MLPEs included in one or more PV generators of a PV array and/or PV installation site, for example, as discussed above in connection with FIGS. 3 to 5, but not limited thereto. According to at least one example embodiment, the processing circuitry may receive distance data obtained from each of the PV generators of the PV array, but the example embodiments are not limited thereto, and for example, the processing circuitry may receive distance data from a subset of the PV generators of the PV array, etc. The entries of the adjacency matrix include the obtained distances between the MLPEs, but may contain missing distance entries due to a particular MLPE being unable to establish a wireless connection and/or unable to transmit/receive pings with another MLPE in the PV array, etc., and therefore the missing entries may be filled with an infinity value (and/or may be filled with a value indicating that the respective distance is unavailable, such as leaving the entry empty, filling the entry with a NULL value, etc.), but the example embodiments are not limited thereto. Additionally, if the measured distance data between two MLPEs are not equal (e.g., a measured distance between a first MLPE and a second MLPE obtained by the first MLPE not being equal to the measured distance obtained by the second MLPE, etc.), for example, due to signal interference, noise, faulty wireless interfaces, etc., the measured distance may be averaged and the average distance may be used in the adjacency matrix, etc.

According to at least one example embodiment, the MLPEs may generate the ToF distance data using UWB communications, but the example embodiments are not limited thereto. UWB communication, in contrast to other location determination technologies, such as GPS, etc., may provide higher accuracy and/or higher resolution PV generator mapping. For example, GPS typically provides a horizontal accuracy of 3 to 10 meters, which is too coarse relative to the physical size of a PV generator. In contrast, UWB localization may deliver sub-meter (e.g., 10 to 30 centimeters) resolution, which provides an order-of-magnitude improvement in measurement precision in comparison to GPS, and therefore reduces and/or confines the positional uncertainty of each PV generator to a small fraction of an individual PV generator, thereby providing meaningful spatial mapping, improved accuracy, and/or also providing fine-grained positioning or alignment. In contrast, the error envelope for GPS would span multiple PV generators, which makes mapping and/or precise positioning impractical for GPS. Additionally, the cost of UWB transceivers may be substantially lower than the cost of GPS sensors, and/or the power consumption of UWB transceivers may be lower than the power consumption of GPS sensors, thereby providing additional benefits as well.

Once the adjacency matrix has been generated, the processing circuitry may solve for the relative coordinates for each of the MLPEs of the PV array using, for example, least-square estimation, but the example embodiments are not limited thereto.

$$f ( {x}_{i} , {x}_{j} , {y}_{i} , {y}_{j} ) = {{d}_{ij}}^{2} - {( {x}_{i} - {x}_{j} )}^{2} - {( {y}_{i} - {y}_{j} )}^{2} , ∀ i and j \qquad [ Equation 1 ]$$

wherein i and j are the indices of the MLPE pair included in the PV array which has n PV generators.

If all of the MLPEs are capable of connecting to all of the other MLPEs in the PV array, there will be

$$\frac{( n - 1 ) x n}{2}$$

measured distances in the adjacency matrix. However, there may be less and/or significantly less measured distances in the adjacency matrix due to, for example, the distance between MLPEs exceeding the maximum range of the wireless communication protocol, signal loss, signal interference, equipment malfunction, design choice (e.g., selecting a subset of MLPEs of the PV array to act as initiators, etc.), etc., and therefore non-linear optimization techniques may be insufficient for purposes of generating a PV array map.

In order to compensate for this issue, according to at least one example embodiment, the processing circuitry may generate a graph based on the adjacency matrix, wherein each vertices (e.g., nodes, etc.) of the graph represents an MLPE (and/or PV generator) included in the PV array and each edge of the graph represents a distance between the corresponding MLPEs, etc., as shown in FIG. 7A. For example, the PV array may include 37 MLPEs represented as nodes 1 to 37 in FIG. 7A, with a plurality of edges connecting each of the nodes, but the example embodiments are not limited thereto. While not shown in FIG. 7A for the sake of clarity, each of the edges may include information indicating the measured distances between two nodes (e.g., the measured distances between two MLPEs and/or PV generator), etc.

In operation S620, and as shown in FIG. 7B, the processing circuitry may segregate the graph into subgraphs (e.g., neighborhoods) based on a size (e.g., physical dimensions) of the PV generators and the distances between the MLPEs of the graph, but is not limited thereto. For example, the processing circuitry may segregate the MLPEs of the graph into separate subgraphs when the distance between any two MLPEs is greater than the desired distance threshold which is set based on the size of the PV generators, etc. According to some example embodiments, the desired distance threshold may be set to the length of the diagonal of a PV generator (e.g., the distance from the top right corner to the bottom left corner of the PV panel, etc.), but the example embodiments are not limited thereto, and other desired distance thresholds may be used. As shown in FIG. 7B, as an example, the graph from FIG. 7A may be segregated into Neighborhoods 1 to 5, wherein Neighborhood 1 includes nodes 31 to 36; Neighborhood 2 includes nodes 21 to 30 and 37 and 38; Neighborhood 3 includes nodes 16 to 20; Neighborhood 4 includes nodes 11 to 15; and/or neighborhood 5 includes nodes 1 to 10, but the example embodiments are not limited thereto. Additionally, the processing circuitry may generate adjacency matrices for each of the neighborhoods during the segregation process, but the example embodiments are not limited thereto.

In operation S630, each of the subgraphs and/or neighborhoods may be decomposed into complete subgraphs, also known as maximal cliques (hereinafter referred to as “cliques”), which do not include any unknown distances (e.g., infinity values, etc.) between nodes, as shown in FIG. 7C. According to at least one example embodiment, each complete subgraph and/or maximal clique is a clique which cannot be extended by adding another node from the graph while still remaining a clique. For example, as shown in FIG. 7C, Neighborhood 1 may include three cliques (e.g., cliques 20 to 22); Neighborhood 2 may include five cliques (e.g., cliques 15 to 19); Neighborhood 3 may include four cliques (e.g., cliques 11 to 14); Neighborhood 4 may include four cliques (e.g., cliques 7 to 10); and/or Neighborhood 5 may include six cliques (e.g., cliques 1 to 6), etc., but the example embodiments are not limited thereto. Additionally, the processing circuitry may generate adjacency matrices for each of the cliques during the desegregation process, but the example embodiments are not limited thereto.

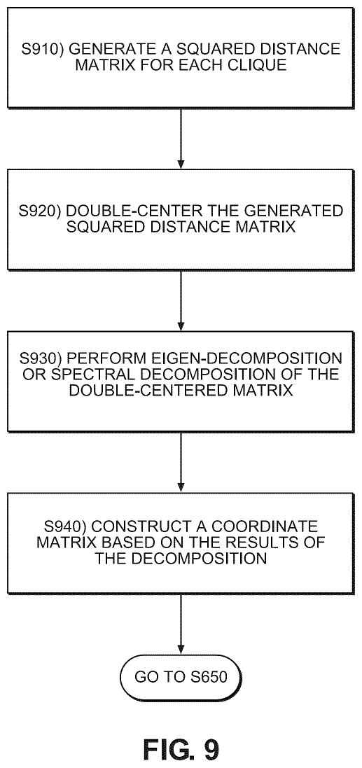

In operation S640, the processing circuitry may identify and/or determine the local coordinates of each node (e.g., MLPE and/or PV generator) included in each clique using, for example, the MultiDimensional Scaling (MDS) algorithm, but the example embodiments are not limited thereto. The output of the performance of the MDS algorithm may reconstruct the geometry of the PV array up to a rigid transformation where the distances between each node and the shapes of the cliques and/or neighborhoods are correct, but the orientation and/or location of the nodes, cliques, and/or neighborhoods are arbitrary. The method for determining the local coordinates of each node will be discussed in greater detail in connection with FIG. 9.

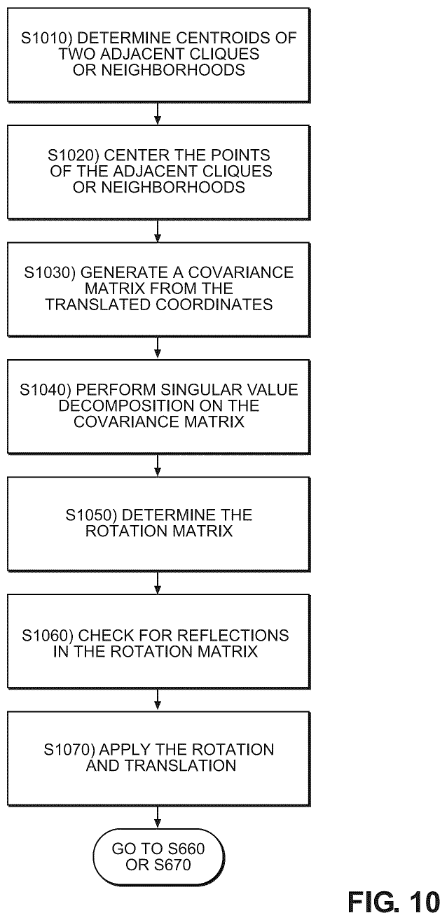

In operation S650, the processing circuitry may identify and/or determine overlaps, e.g., one or more common nodes, between individual cliques in each neighborhood and perform a rigid transformation on the cliques in order to translate and rotate the cliques relative to each other, thereby determining the relative positioning of the cliques and/or nodes relative to each other. For example, in Neighborhood 1 of FIG. 7C, the common nodes between cliques 21 and 20 are nodes 33 and 35, the common nodes between clique 22 and clique 20 are nodes 32 and 35, and the common node between clique 21 and clique 22 is node 35, etc. According to at least one example embodiment, the Kabsch algorithm may be used to perform the rigid transformation, but the example embodiments are not limited thereto, and other algorithms may be used. More specifically, the Kabsch algorithm may be performed in order to perform a rigid transformation of the local coordinates generated by the MDS algorithm (e.g., the MDS coordinates) to determine the correct orientation and/or location of the nodes, cliques, and/or neighborhoods, thereby determining the real coordinates of the PV array. The method for performing rigid transformation will be discussed in greater detail in connection with FIG. 10.

Additionally, according to some example embodiments, the processing circuitry may identify and/or determine overlaps involving two or more common nodes in adjacent cliques in a neighborhood such that the following relationship is preserved in order to identify rigid neighborhoods, e.g., neighborhoods which have an optimized and/or a single positioning solution.

$$D \geq ( 2 * n ) - 3 \qquad [ Equation 2 ]$$

wherein D=the number of edges (e.g., measured distances) in the subgraph and/or neighborhood; and n is the number of nodes (e.g., MLPEs and/or PV generators) in the subgraph and/or neighborhood.

For example, as shown in FIG. 7C, Neighborhoods 1, 2, and 5 satisfy the relationship of Equation 2, but Neighborhoods 3 and 4 do not. In the case of Neighborhoods 3 and 4, each of these neighborhoods have 5 nodes and 4 edges, and thus can have an infinite number of possible positioning solutions that are all mathematically correct. For these neighborhoods, the processing circuitry may further place one or more additional constraints on the neighborhood in order to achieve a rigid neighborhood. For example, an additional constraint may be to determine a known position (e.g., absolute position, etc.) of one of the MLPEs and/or PV generators included in the non-rigid neighborhood (e.g., using surveying techniques, using GPS, determining the position based on the known absolute position of landmark, etc.), and select a positioning solution that maximizes the distances between the nodes where the edge is not available, thereby producing a unique solution where all of the cliques in the neighborhood would be aligned together. However, the example embodiments are not limited thereto, and other constraints which lead to a unique solution may be used.

In operation S660, the processing circuitry may iteratively identify and/or determine overlaps (e.g., common nodes) between neighborhoods and may perform the rigid transformation, e.g., the Kabsch algorithm, etc., to translate and/or rotate the neighborhoods in order to connect the neighborhoods together. According to some example embodiments, the processing circuitry may determine the common nodes between neighborhoods based on the entries in the original adjacency matrix of the entire PV array generated in operation S610 (e.g., the edges shown in FIG. 7A), but the example embodiments are not limited thereto. As another example, the processing circuitry may determine the common nodes between neighborhoods using a second distance threshold which is larger than the first distance threshold, etc. Once the neighborhoods have been connected, the processing circuitry may generate a map as shown in FIG. 7D, wherein the relative positions of the neighborhoods are set and/or rigid, but the example embodiments are not limited thereto. In operation S670, the processing circuitry may output a PV generator array map based on the generated map of operation S660 and the dimensions of each individual PV generator.

For example, as shown in FIG. 8, the processing circuitry may generate a PV array map which accurately displays the outline of each PV generator in the PV array by determining the relative positioning and/or orientation of the PV generators (e.g., may fit the outline of the PV generators onto the map of FIG. 7D) based on the determined relative positioning of the MLPE, the determined relative positioning of the other MLPEs in its neighborhood and/or clique, and/or the dimensions of the PV generators, but is not limited thereto. For example, assuming that the MLPEs of each PV generator is in the center of the PV generator and the dimensions of each PV generator are the same, if the distance between the MLPE corresponding to a first node (e.g., node 6) and the MLPE corresponding to a second node (e.g., node 122) is equal to or greater than the known length of a PV generator, then the processing circuitry may determine that the PV generators corresponding to the first node and the second node are positioned lengthwise and may draw and/or generate the PV array map accordingly, but the example embodiments are not limited thereto, and for example, the processing circuitry may use the distances and/or angles of one or more additional nodes to determine the positioning of the outline of each of the PV generators on the map, etc. Conversely, if the distance between a first node (e.g., node 6) and a second node (e.g., node 5) is less than the known length of a PV generator, but is greater than or equal to the known width of the PV generator, the processing circuitry may determine that the PV generators corresponding to the first node and the second node are positioned widthwise, etc., and may draw and/or generate the PV array map accordingly.

Further, the processing circuitry may rotate the outline of one or more of the PV generators such that the outlines of the PV generators do not overlap with each other while maintaining the relative positioning of the PV generators determined in operation S660.

According to some example embodiments, the processing circuitry may further overlay the generated PV array map over an existing image and/or map of the installation site to provide more detail to the PV array map, and may display a user interface including the generated PV array map on the gateway computer, a user device, etc. For example, if an aerial photograph, a plat, a street map, a topology map, a real-time video, etc., is available of the PV array site, the processing circuitry may overlay the generated PV array map onto the image, etc., but the example embodiments are not limited thereto. Moreover, the processing circuitry may add additional information to the generated PV array map, such as monitoring data and/or real-time monitoring data (e.g., energy PV output by each individual PV generator, operational status of the PV generator, error notifications of the PV generator, etc.) on the generated PV array map, thereby providing PV array operators, utility companies, homeowners, service technicians, etc., accurate information related to the operation of the PV array. For example, if a PV generator is outputting less energy than other PV generators within the same clique and/or neighborhood, an alert may be transmitted to a user device of a service technician to investigate the identified PV generator along with the location of the PV generator on the PV array map, etc.

According to some example embodiments, the gateway computer 200 may receive health reports from the array of PV generators, and may transmit an initiation signal in response to a determination that a change (e.g., a decrease) in power generated by one or more PV generators is greater than a threshold value, a disruption and/or disconnection of communication from neighboring MLPEs, etc. The initiation signal may include instructions for a MLPE included in the array of PV generators (e.g., the MLPE with the decreased power generation and/or a neighboring MLPE) to initiate a determination of the ToA between the selected MLPE and the neighboring MLPE. The gateway computer may receive an update from the selected MLPE and revise the map based on the received update.

Accordingly, the gateway computer 200 may be aware when a change in the PV generator array has occurred, for example, when a PV generator has been moved and/or removed from the array, a PV generator has been damaged, an obstruction has occurred, the powerline and/or wireless connection between PV generator has been disconnected, etc., and the relevant PV generators may be identified in the PV array map and may be transmitted to a technician's user device for display on a monitor or the like.

Further, the map of the PV array may be continuously updated, periodically updated, and/or dynamically updated without expensive and/or time-consuming operation. For example, when PV generators are moved to different locations within the PV array, new PV generators are added to the PV array, and/or PV generators are removed from the PV array, the PV map may be automatically updated, or may be updated on demand in a more time efficient and/or less expensive manner, using the methods discussed above.

For example, as shown in FIG. 7A, the PV generators corresponding to nodes 37 and 38 may be originally located in positions separate from the remainder of the PV generators of the PV array (which is indicated by the lack of connections between nodes 37 and 38 with the other nodes of the PV array). When the PV generators corresponding to nodes 37 and 38 are moved and/or installed within the PV array (e.g., installed in Neighborhood 2 in FIGS. 7B to 7D), the change may be detected and/or immediately detected based on the wireless communication pinging between nodes 37 and 38 and nodes 21, 22, 23, and/or 24, etc., and the PV map may be updated to reflect the change in position of nodes 38 and 37, etc. Accordingly, the PV array map may be generated automatically with no manual intervention.

FIG. 9 is a flowchart illustrating an example method for determining the local coordinates of each node in a clique according to some example embodiments.

According to at least one example embodiment, the processing circuitry may use the MDS algorithm to find local coordinates of the PV generator locations for each clique based on the adjacency matrices of distances for each clique.

In operation S910, the processing circuitry may generate a squared distance matrix D (2) containing the squared distances of each entry in the adjacency matrix corresponding to each clique, wherein each entry in the adjacency matrix corresponds to the measured distance between two MLPEs of two PV generators.

For example, assuming that the adjacency matrix for a first clique is represented by matrix D below, where each element dᵢⱼ represents the distance between points i and j:

$$D = [ \begin{matrix}0 & {d}_{12} & {d}_{13} & … & {d}_{1 n} \\ {d}_{21} & 0 & {d}_{23} & … & {d}_{2 n} \\ {d}_{31} & {d}_{32} & 0 & … & {d}_{3 n} \\ ⋮ & ⋮ & ⋮ & ⋱ & ⋮ \\ {d}_{n 1} & {d}_{n 2} & {d}_{n 3} & … & 0\end{matrix} ]$$

The squared distance matrix D⁽²⁾ may be calculated using the following equation:

$${D}^{( 2 )} = [ {d}_{ij}^{2} ] \qquad [ Equation 3 ]$$

Next, in operation S920, the processing circuitry may generate and/or construct a centering matrix J to centralize the squared distance matrix D⁽²⁾, wherein

$$J = I - \frac{1}{n} {11}^{T} \qquad [ Equation 4 ]$$

wherein I is an n×n identity matrix; and 1 is an n×1 vector of ones.

The centering matrix J is used to double center the squared distance matrix D⁽²⁾, or in other words, removing both row and column means from the squared distance matrix D⁽²⁾, thereby ensuring that the final coordinate system is centered around an origin in a new dimensional space.

The processing circuitry may next compute and/or generate a double-centered matrix B based on the centering matrix J and the squared distance matrix D⁽²⁾:

$$B = - \frac{1}{2} {JD}^{2} J \qquad [ Equation 5 ]$$

In operation S930, the processing circuitry may perform a decomposition, e.g., an eigen-decomposition or spectral decomposition, etc., of the double-centered matrix B, for example, using the following equation:

$$B = V Λ {V}^{T} \qquad [ Equation 6 ]$$

wherein V is the matrix of eigenvectors, each column representing an eigenvector; A is the diagonal matrix of eigenvalues sorted in descending order: λ₁≥λ₂≥ . . . ≥λₙ.

Next, the processing circuitry may select the top m eigenvalues (and corresponding eigenvectors) to obtain an m-dimensional representation, wherein m is typically 2 or 3, but not limited thereto.

In operation S940, the processing circuitry may construct and/or generate a coordinate matrix X:

$$X = {V}_{m} {Λ}_{m}^{\{ \frac{1}{2} \}} \qquad [ Equation 7 ]$$

wherein Λₘ is a diagonal matrix Λₘ containing the m largest positive eigenvalues and Vₘ is an n×m matrix whose columns are the eigenvectors corresponding to the m eigenvalues:

$${Λ}_{m} = [ \begin{matrix}{λ}_{1} & 0 & … & 0 \\ 0 & {λ}_{2} & … & 0 \\ ⋮ & ⋮ & ⋱ & ⋮ \\ 0 & 0 & … & {λ}_{m}\end{matrix} ]$$

$${V}_{m} = [ {v}_{1} , {v}_{2} , ... , {v}_{m} ]$$

Each row of the coordinate matrix X represents the coordinates of the corresponding point in the new, lower-dimensional space:

$$X = [ \begin{matrix}{x}_{11} & {x}_{12} & … & {x}_{1 m} \\ {x}_{21} & {x}_{22} & … & {x}_{2 m} \\ ⋮ & ⋮ & ⋱ & ⋮ \\ {x}_{n 1} & {x}_{n 2} & … & {x}_{nm}\end{matrix} ]$$

The magnitude of eigenvalues of the coordinate matrix X indicates how much variance or distance information each dimension captures. Rows in the coordinate matrix X represent the local coordinates of each point (e.g., each MLPE) in the reduced-dimensional space, and therefore points (e.g., MLPEs) that are close in the original adjacency matrix remain close in the lower-dimensional space.

FIG. 10 is a flowchart illustrating an example method for performing rigid transformation according to some example embodiments.

According to at least one example embodiment, the processing circuitry may use the Kabsch algorithm to determine the optimal rotation matrix that best aligns two sets of corresponding points, e.g., the cliques in a neighborhood as discussed in operation S650 of FIG. 6, or the neighborhoods in the complete graph as discussed in operation S660 of FIG. 6, in two- or three-dimensional space. The two sets of corresponding points may be expressed as P={p₁, p₂, . . . , p_{N}}, and Q={q₁, q₂, . . . , q_{N}}.

In operation S1010, the processing circuitry may determine centroids C_{P} and C_{Q} (e.g., mean values) of the two sets of points P and Q (e.g., two sets of adjacent cliques or two sets of adjacent neighborhoods, etc.), using the following equation:

$${c}_{P} = \frac{1}{N} {\sum }_{i = 1}^{N} {p}_{i} , {c}_{Q} = \frac{1}{N} {\sum }_{i = 1}^{N} {q}_{i} \qquad [ Equation 8 ]$$

In operation S1020, the processing circuitry may center the points of the two sets of points P and Q by subtracting their centroids, C_{P} and C_{Q}, respectively, using the following equation:

$${P}^{′} = P - {c}_{P} , {Q}^{′} = Q - {c}_{Q} \qquad [ Equation 9 ]$$

The resulting P′ and Q′ point sets are translations of the original P and Q point sets which have the respective centroid, C_{P} and C_{Q}, at the origin.

In operation S1030, the processing circuitry may generate a covariance matrix H from the translated point sets P′ and Q′ using the following equation:

$$H = {P}^{′ T} {Q}^{′} \qquad [ Equation 10 ]$$

wherein His a 2×2 matrix when using two-dimensional points.

The covariance matrix H represents the relationship between the two sets of points, P and Q.

In operation S1040, the processing circuitry may perform singular value decomposition (SVD) on the covariance matrix H using the following equation:

$$H = U \sum {V}^{T} \qquad [ Equation 11 ]$$

wherein U and V are orthogonal and Σ is diagonal.

By performing SVD on the covariance matrix H, the covariance matrix H is decomposed into matrices that capture the rotation needed to align the two sets of points.

In operation S1050, the processing circuitry may determine and/or find a rotation matrix R based on the results from the performance of the SVD in order to calculate the optimal rotation matrix that minimizes the root mean squared deviation between the two sets of points.

$$R = {VU}^{T} \qquad [ Equation 12 ]$$

In operation S1060, the processing circuitry may check and/or determine whether reflections exist in the rotation matrix R using the following equation.

$$det ( R ) = + 1 \qquad [ Equation 13 ]$$

If det(R)<0, the processing circuitry may adjust for reflection by flipping the sign of the second column of V:

$$V [ : , 1 ] ← - V [ : , 1 ] , R = {VU}^{T} \qquad [ Equation 14 ]$$

In operation S1070, the processing circuitry may apply the rotation and translation to compute the aligned points P_{aligned}.

$${P}_{aligned} = ( P - {c}_{P} ) R + {c}_{Q} \qquad [ Equation 15 ]$$

The resulting aligned points P_{aligned} may provide a rigid-body transformation (e.g., a rotation given by the matrix R and a translation t) of the adjacent cliques or neighborhoods, particularly if the adjacent cliques or neighborhoods include two or more common nodes (e.g., nodes that are present in both cliques or neighborhoods). To align the MDS points (resulting from operation S940), the processing circuitry may apply the transformation to each point (x, y) in the corresponding MDS set as follows, wherein Equation 15 is rewritten as Equation 16 and separated into Equation 17 to determine a set of [x,y] coordinates:

$${P}_{aligned} = PR + t \qquad [ Equation 16 ]$$

wherein R is the optimal Kabsch rotation; t is the optimal Kabsch translation and t=c_{Q}−c_{P}·R, which results in Equation 17.

$${x}_{aligned} = R \cdot {x}_{MDS} + {t}_{x} \qquad [ Equation 17 ]$$

$${y}_{aligned} = R \cdot {y}_{MDS} + {t}_{y}$$

As described above, an array of PV generators including wirelessly connected MLPEs may automatically determine the location and adjacency of individual PV generators using relative location data thereby reducing installation, maintenance, and/or asset-tracking times and costs.

Although the terms first, second, etc. may be used herein to describe various elements, these elements should not be limited by these terms. These terms are only used to distinguish one element from another. For example, a first element could be termed a second element, and similarly, a second element could be termed a first element, without departing from the scope of this disclosure. As used herein, the term “and/or,” includes any and all combinations of one or more of the associated listed items.

When an element is referred to as being “connected,” or “coupled,” to another element, it can be directly connected or coupled to the other element or intervening elements may be present. By contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular example embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Specific details are provided in the preceding description to provide a thorough understanding of example embodiments. However, it will be understood by one of ordinary skill in the art that example embodiments may be practiced without these specific details. For example, systems may be shown in block diagrams so as not to obscure the example embodiments in unnecessary detail. In other instances, well-known processes, structures, and techniques may be shown without unnecessary detail in order to avoid obscuring example embodiments.

As discussed herein, illustrative example embodiments will be described with reference to acts and symbolic representations of operations (e.g., in the form of flow charts, flow diagrams, data flow diagrams, structure diagrams, block diagrams, etc.) that may be implemented as program modules or functional processes include routines, programs, objects, components, data structures, etc., that perform particular tasks or implement particular abstract data types and may be implemented using existing hardware at, for example, existing switches, hubs, routers, or other network elements, equipment and/or hardware. Such existing hardware may be processing or control circuitry such as, but not limited to, one or more processors, one or more Central Processing Units (CPUs), one or more controllers, one or more arithmetic logic units (ALUs), one or more digital signal processors (DSPs), one or more microcomputers, one or more field programmable gate arrays (FPGAs), one or more System-on-Chips (SoCs), one or more programmable logic units (PLUS), one or more microprocessors, one or more Application Specific Integrated Circuits (ASICs), or any other device or devices capable of responding to and executing instructions in a defined manner.

Although a flow chart may describe the operations as a sequential process, many of the operations may be performed in parallel, concurrently, or simultaneously. In addition, the order of the operations may be re-arranged. A process may be terminated when its operations are completed, but may also have additional steps not included in the figure. A process may correspond to a method, function, procedure, subroutine, subprogram, etc. When a process corresponds to a function, its termination may correspond to a return of the function to the calling function or the main function.

The terms “including” and/or “having,” as used herein, are defined as comprising (i.e., open language). The term “coupled,” as used herein, is defined as connected, although not necessarily directly, and not necessarily mechanically. Terminology derived from the word “indicating” (e.g., “indicates” and “indication”) is intended to encompass all the various techniques available for communicating or referencing the object/information being indicated. Some, but not all, examples of techniques available for communicating or referencing the object/information being indicated include the conveyance of the object/information being indicated, the conveyance of an identifier of the object/information being indicated, the conveyance of information used to generate the object/information being indicated, the conveyance of some part or portion of the object/information being indicated, the conveyance of some derivation of the object/information being indicated, and the conveyance of some symbol representing the object/information being indicated.

Benefits, other advantages, and solutions to problems have been described above with regard to specific example embodiments of the inventive concepts. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims.

What is claimed is:

1. A computing device comprising:
memory having computer readable instructions stored thereon; and
processing circuitry configured to execute the computer readable instructions to cause the computing device to,
obtain a plurality of distance measurements between a plurality of photovoltaic (PV) generators, the distance measurements determined based on time-of-flight wireless signal data transmitted between the plurality of PV generators,
generate an initial adjacency matrix based on the plurality of distance measurements,
generate an initial graph of the plurality of PV generators based on the initial adjacency matrix,
generate a map corresponding to locations of the plurality of PV generators based on the initial graph, and
display the map on a graphical user interface.

2. The computing device of claim 1, wherein
the initial graph includes a plurality of nodes corresponding to the plurality of PV generators and edges corresponding to distances between each of the plurality of PV generators.

3. The computing device of claim 2, wherein
the initial adjacency matrix is an incomplete adjacency matrix; and
the processing circuitry is further configured to execute the computer readable instructions to further cause the computing device to generate the map by:
segregating the initial graph into a plurality of neighborhood graphs based on a size of each of the plurality of PV generators and the distances between each of the plurality of PV generators.

4. The computing device of claim 3, wherein the processing circuitry is further configured to execute the computer readable instructions to further cause the computing device to generate the map by:
decomposing each neighborhood graph of the plurality of neighborhood graphs into a clique.

5. The computing device of claim 4, wherein an adjacency matrix corresponding to each clique does not contain any unknown distances.

6. The computing device of claim 4, wherein the processing circuitry is further configured to execute the computer readable instructions to further cause the computing device to generate the map by:
determining local coordinates of each node included in each clique using multi-dimensional scaling.

7. The computing device of claim 4, wherein the processing circuitry is further configured to execute the computer readable instructions to further cause the computing device to generate the map by:
identifying a plurality of common nodes in the plurality of cliques, the plurality of common nodes being two or more nodes included in two or more cliques of the plurality of cliques; and
translating and rotating the two or more cliques corresponding to the plurality of common nodes.

8. The computing device of claim 7, wherein the processing circuitry is further configured to execute the computer readable instructions to further cause the computing device to generate the map by:
connecting the translated and rotated two or more cliques into a neighborhood.

9. The computing device of claim 8, wherein the processing circuitry is further configured to execute the computer readable instructions to further cause the computing device to generate the map by:
connecting a plurality of neighborhoods based on the plurality of common nodes included in the plurality of neighborhoods to form the generated map.

10. A photovoltaic (PV) generator system comprising:
a plurality of PV generators; and
at least one computing device configured to,
obtain a plurality of distance measurements between the plurality of PV generators, the distance measurements determined based on time-of-flight wireless signal data transmitted between the plurality of PV generators,
generate an initial adjacency matrix based on the plurality of distance measurements,
generate an initial graph of the plurality of PV generators based on the initial adjacency matrix,
generate a map corresponding to locations of the plurality of PV generators based on the initial graph, and
display the map on a graphical user interface.

11. The system of claim 10, wherein
each of the plurality of PV generators includes at least one wireless transceiver; and
each of the plurality of PV generators are configured to,
wirelessly transmit at least one ping data packet to at least one neighboring PV generator of the plurality of PV generators,
wirelessly receive at least one responsive data packet from the at least one neighboring PV generator in response to the at least one ping data packet, and determine a distance to the at least one neighboring PV generator based on a time-of-flight of the at least one ping data packet and the at least one responsive data packet.

12. The system of claim 11, wherein the at least one wireless transceiver is at least one of:
an ultrawideband (UWB) transceiver, a Bluetooth transceiver, a WiFi transceiver, a cellular transceiver, or any combinations thereof.

13. The system of claim 10, wherein
the initial graph includes a plurality of nodes corresponding to the plurality of PV generators and edges corresponding to distances between each of the plurality of PV generators.

14. The system of claim 10, wherein
the initial adjacency matrix is an incomplete adjacency matrix; and
the at least one computing device is further configured to generate the map by:
segregating the initial graph into a plurality of neighborhood graphs based on a size of each of the plurality of PV generators and the distances between each of the plurality of PV generators, and
decomposing each neighborhood graph of the plurality of neighborhood graphs into a clique.

15. The system of claim 14, wherein an adjacency matrix corresponding to each clique does not contain any unknown distances.

16. The system of claim 14, wherein the at least one computing device is further configured to generate the map by:
determining local coordinates of each node included in each clique using multi-dimensional scaling.

17. The system of claim 14, wherein the at least one computing device is further configured to generate the map by:
identifying a plurality of common nodes in the plurality of cliques, the plurality of common nodes being two or more nodes included in two or more cliques of the plurality of cliques;
translating and rotating the two or more cliques corresponding to the plurality of common nodes;
connecting the translated and rotated two or more cliques into a neighborhood; and
connecting a plurality of neighborhoods based on the plurality of common nodes included in the plurality of neighborhoods to form the generated map.

18. A method of operating a computing device, the method comprising:
obtaining a plurality of distance measurements between a plurality of photovoltaic (PV) generators, the distance measurements determined based on time-of-flight wireless signal data transmitted between the plurality of PV generators;
generating an initial adjacency matrix based on the plurality of distance measurements;
generating an initial graph of the plurality of PV generators based on the initial adjacency matrix;
generate a map corresponding to locations of the plurality of PV generators based on the initial graph; and
displaying the map on a graphical user interface.

19. The method of claim 18, wherein
the initial adjacency matrix is an incomplete adjacency matrix; and
the generating the map further includes,
segregating the initial graph into a plurality of neighborhood graphs based on a size of each of the plurality of PV generators and the distances between each of the plurality of PV generators, and
decomposing each neighborhood graph of the plurality of neighborhood graphs into a clique.

20. The method of claim 19, wherein the generating the map further includes:
identifying a plurality of common nodes in the plurality of cliques, the plurality of common nodes being two or more nodes included in two or more cliques of the plurality of cliques;
translating and rotating the two or more cliques corresponding to the plurality of common nodes;
connecting the translated and rotated two or more cliques into a neighborhood; and
connecting a plurality of neighborhoods based on the plurality of common nodes included in the plurality of neighborhoods to form the generated map.
